(19) United States
(12) Patent Application Publication
(10) Pub. No.: US 2026/0275914 A1
(43) Pub. Date: Sep. 17, 2026

(54) EVAPORATIVE ENGINE COOLING SYSTEM

(71) Applicant: Signal Power Group Operating LLC, Oro Valley, AZ (US)

(72) Inventor: Dustin Martin, Cypress, TX (US)

(73) Assignee: Signal Power Group Operating LLC, Oro Valley, AZ (US)

(21) Appl. No.: 19/566,883

(22) Filed: Mar. 13, 2026

Related U.S. Application Data
(60) Provisional application No. 63/773,412, filed on Mar. 17, 2025.

(51) Int. Cl. F02C 7/18; E21B 43/26; F02C 7/32; F02C 9/00

(52) U.S. Cl. CPC F02C 7/18; E21B 43/2607; F02C 7/32; F02C 9/00; F05D 2260/232

(57) ABSTRACT

An improved hydraulic fracturing power system is provided. The power system drives a hydraulic fracturing pump with a turbine engine. Features are provided to increase the power generation capacity of the turbine engine, especially in hot environments. For instance, evaporative cooling features cool, and thus densify, inflowing airflow to the turbine engine, improving operation of the turbine engine. Sensors may connect to a controller that controls instillation of fluid into the evaporative cooling features thereby controlling characteristics of cooling of the airflow by the evaporative cooling features.

### CROSS-REFERENCE TO RELATED APPLICATIONS

This application claims priority to, and the benefit of, U.S. Provisional Patent Application Ser. No. 63/773,412, filed Mar. 17, 2025 entitled “EVAPORATIVE ENGINE COOLING SYSTEM.” The content of the aforementioned patent application is herein incorporated by reference.

### FIELD

This disclosure generally relates to devices, systems, and methods for turbine efficiency, and more particularly to cooling systems in fracing-related turbines.

### BACKGROUND

In the field of fracing for natural gas, a hole is typically drilled down into a shale layer, and along the shale layer, and then through known methods, water and sand are pumped into the shale to crack the shale and hold it open, such that in later stages of the fracing operation, gas can flow out of the shale layer, to be collected on the surface. The pumping of the water down, sometimes at great depths, such as a mile deep, and pumping the water pressure sufficiently high to crack the shale rock underground can be performed by a turbine driving a water pump.

The turbine is a useful engine because of the readily available natural gas to power the turbine to spin an output drive shaft, which operates the pump. However, typical fracing pump driving turbines are subject to operation in very different climate environments. In many instances, the turbines are called on to operate in hot environments. However, hot temperatures diminish the density of ambient air, diminishing the volume of oxidizer ingested by a turbine ingesting ambient air. This causes the turbine to operate with sub-optimal efficiency and/or sub-optimal power output. Thus, there is a need for a mechanism to ameliorate hot air temperatures and improve turbine performance.

### SUMMARY

An evaporative cooling apparatus for a turbine engine is provided. The evaporative cooling apparatus may have various features. For instance, the evaporative cooling apparatus may include an evaporative media disposed in an airflow path of an air inlet into a turbine engine. The evaporative cooling apparatus may include a fluid separator disposed in an airflow path of an air inlet into a turbine engine. The fluid separator may be positioned between the evaporative media and the air inlet. The evaporative media introduces fluid into the airflow path to cool an airflow in the airflow path to create cooled airflow. The fluid separator recovers fluid from the cooled airflow to create cooled and dried airflow. The cold and dried airflow passes from the fluid separator into the air inlet of the turbine engine.

One or more further features may also be provided. For instance, the evaporative cooling apparatus may include a differential pressure sensor. The sensor may have sensing elements disposed on opposite sides of the evaporative media to detect a difference in pressure, the difference corresponding to a clogging of the evaporative media. The evaporative cooling apparatus may include a fluid injection pump attached to the evaporative media to instill the fluid into the evaporative media. The evaporative cooling apparatus may include a fluid source attached to the fluid injection pump to provide the fluid to the fluid injection pump. The fluid separator may include a separated fluid outlet connected to the fluid source to provide a recycled portion of the fluid.

The evaporative cooling apparatus may include a controller. The controller may be connected to the fluid injection pump and a sensor array. The controller may be configured to modulate an amount of the fluid selectively instilled into the evaporative media in response to the sensor array. The sensor array may include a differential pressure sensor having sensing elements disposed on opposite sides of the evaporative media to detect a difference in pressure. The difference may correspond to at least one of (1) a fluid saturation of the evaporative media and (2) a clogging of the evaporative media.

The sensor array may include a humidity sensor to detect an ambient humidity. The sensor array may include an input temperature sensor to detect a temperature of the airflow in the airflow path that is flowing into the evaporative media. The sensor array may include an output temperature sensor to detect a temperature of the cooled airflow flowing out of the evaporative media.

The controller may selectively increase the amount of the fluid selectively instilled into the evaporative media in response to the output temperature sensor indicating a temperature above a first threshold. The controller may be a logical component of an engine full authority digital electronic controller (FADEC) that controls the turbine engine. The controller may be in operative communication with an engine full authority digital electronic controller (FADEC) that controls the turbine engine to form an integrated control unit comprising the FADEC and the controller.

An improved hydraulic fracturing power system is provided. The system may include a turbine engine having an inlet, an exhaust outlet, and a power shaft to drive a load. The system may include a transmission connected to the power shaft of the turbine engine. The system may include a hydraulic fracturing pump connected to the transmission as the load. The transmission couples motive force from the gas turbine energy to the hydraulic fracturing pump to operate the hydraulic fracturing pump. The system may include an evaporative cooling apparatus disposed adjacent to the inlet to cool airflow into the turbine engine.

One or more further features may also be provided. For instance, a fluid separator may be disposed between the evaporative cooling apparatus and the inlet to separate fluid from the airflow prior to the inlet of the turbine engine. In various embodiments, the system includes a fluid injection pump and a controller. The fluid injection pump is connected to an evaporative media of the evaporative cooling apparatus. The fluid injection pump instils fluid into the evaporative cooling apparatus to induce evaporative cooling of the airflow. The controller is connected to the fluid injection pump to modulate an amount of the fluid to increase or decrease a cooling effect of the evaporative cooling apparatus. The system may include a sensor array. The sensor array may be connected to the controller. The sensor array may include an output temperature sensor to measure a temperature of the airflow between the evaporative media and the inlet of the turbine engine. The controller may increase the amount of fluid to decrease the temperature.

The improved hydraulic fracturing power system may include a full-authority digital engine controller (FADEC) controlling the turbine engine. The controller may be connected to the FADEC. The controller may increase the amount of fluid to decrease the temperature in response to an instruction from the FADEC to increase a power delivered by the turbine engine to the load. The controller may be a logical aspect of the FADEC and may be integrated therein.

A turbine engine is provided. The turbine engine may include an inlet to receive an airflow. The engine may include a compressor section to compress the airflow. The engine may include a power section to combust a fuel oxidized by the airflow to generate power and combustion products. The engine may include a power shaft to output the power to a load. The engine may include an outlet to expel the combustion products. The engine may include an evaporative cooling apparatus disposed adjacent to the inlet. The evaporative cooling apparatus may receive the airflow prior to the airflow passing into the inlet. The evaporative cooling apparatus may cool the airflow to increase the power generated by the combusting the fuel oxidized by the airflow by increasing a density of a gas of the airflow.

The turbine engine may have one or more additional features. For instance, the evaporative cooling apparatus of the engine may include further aspects. The evaporative cooling apparatus may include an evaporative media disposed in a path of the airflow into the inlet. The evaporative cooling apparatus may include a fluid separator disposed in the path of the airflow and positioned between the first evaporative media and the inlet. The evaporative media may introduce fluid into the airflow to cool the airflow to create cooled airflow. The fluid separator recovers fluid from the cooled airflow to create cooled and dried airflow. The cold and dried airflow passes from the fluid separator into the inlet to receive the airflow.

The turbine engine may include one or more additional aspect. For instance, the turbine engine may include a fluid injection pump and a controller. The fluid injection pump may be connected to an evaporative media of the evaporative cooling apparatus. The fluid injection pump instils fluid into the evaporative cooling apparatus to induce evaporative cooling of the airflow. The controller may be connected to the fluid injection pump to modulate an amount of the fluid to increase or decrease a cooling effect of the evaporative cooling apparatus in response to an instruction from a full authority digital engine controller (FADEC) controlling the turbine engine. The instruction may be an instruction to increase the power generated by the turbine engine.

### BRIEF DESCRIPTION OF DRAWINGS

A more complete understanding of the present disclosure may be derived by referring to the detailed description and claims when considered in connection with the Figures, wherein like reference numbers refer to similar elements throughout the Figures, and:

FIG. 1 is an illustration of an improved hydraulic fracturing power system, in accordance with various embodiments;

FIG. 2A is a diagram of a turbine engine having an evaporative cooling apparatus, in accordance with various embodiments;

FIG. 2B is a diagram characterizing various beneficial cooling effects of evaporative cooling, in accordance with various embodiments; and

FIG. 3 is a detailed block diagram of an example improved hydraulic fracturing power system, in accordance with various embodiments.

### DETAILED DESCRIPTION

Hydraulic fracturing power systems often include powerful engines driving pumps under significant load. These engines consume fuel to generate power. This fuel is burned with an oxidizer, such as ambient air having oxygen therein. In various embodiments, the engines are turbine engines. Turbine engines require adequate oxidizer to produce an intended amount of power and to operate with an intended efficiency. However, hot air is less dense than cool air and correspondingly, a given volume of hot air contains less oxidizer than cool air. Thus, when operating in hot environments, turbine engines are prone to producing less power or operating with less efficiency.

This disclosure includes an improved hydraulic fracturing power system to address this consideration. This disclosure includes a system with an evaporative cooling apparatus to cool the inflowing air that is entering the turbine engine to provide oxidizer to the combustion process, thus densifying the inflowing air and increasing the amount of oxidizer ingested by the engine with each unit volume of air.

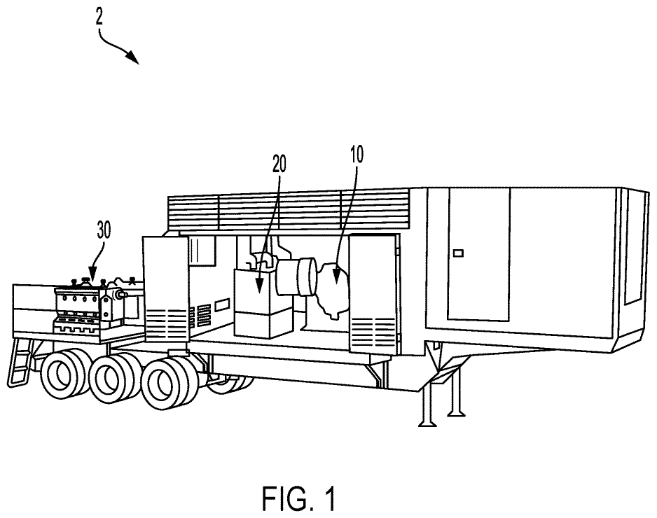

With reference to FIG. 1, an improved hydraulic fracturing power system 2 is provided. The improved hydraulic fracturing power system 2 may be a trailer-mounted system for rapid deployment and repositioning. The improved hydraulic fracturing power system 2 may include a turbine engine 10. The turbine engine 10 may be a high-bypass turbine, or a low-bypass turbine, or may be an industrial turbine, or an aviation turbine, or any other turbine engine as desired. The turbine engine 10 may be a diesel turbine, a kerosene turbine, a natural gas turbine or any other type of turbine as desired. In various embodiments, for use with a hydraulic fracing pump or another oil and gas production or exploration embodiment, the turbine engine 10 may be a natural gas turbine and may burn readily available natural gas being produced from a subterranean geologic structure.

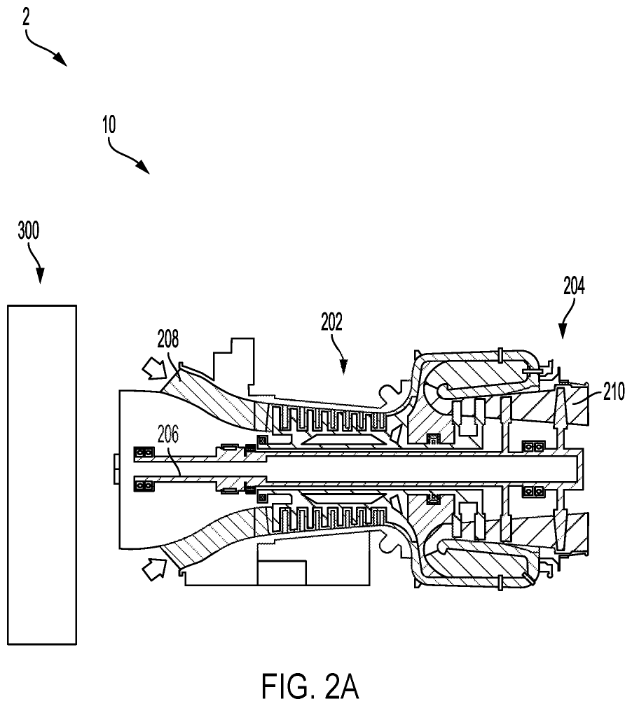

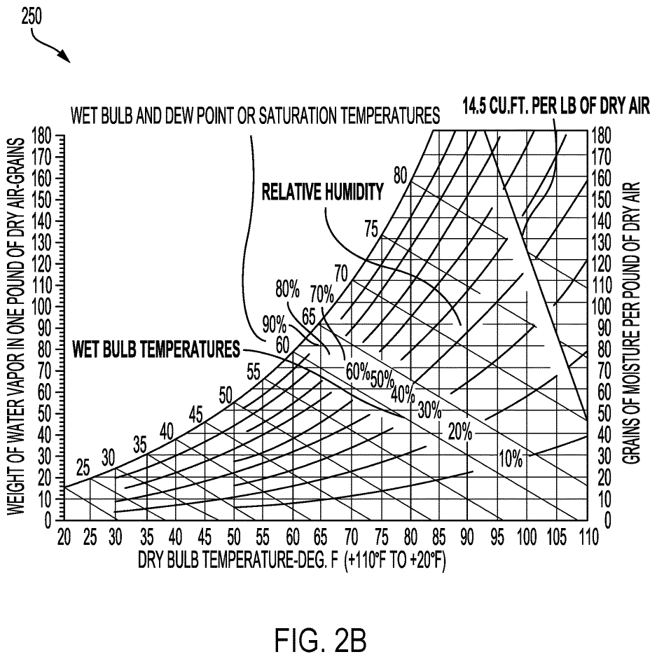

The improved hydraulic fracturing power system 2 may include a transmission 20. The transmission 20 may connect to a power shaft (FIGS. 2, 206) of the turbine engine 10 and may have one or more gears to provide a gear ratio. The transmission 20 may have a neutral gear. The transmission 20 may connect to a hydraulic fracturing pump 30 to provide power from the turbine engine 10 to the hydraulic fracturing pump 30 to operate the hydraulic fracturing pump 30.

As briefly mentioned, the improved hydraulic fracturing power system 2 may have a hydraulic fracturing pump 30. The pump system may be configured to pump a fluid (e.g., water and/or a sand/water mixture) into the ground to pressurize a portion of the ground to cause the rocks and other subterranean structures in that portion of the ground to crack and remain cracked, for the purpose of extracting hydrocarbon, such as oil or gas, from the ground in proximity to that portion of the ground. Thus, the hydraulic fracturing pump 30 may facilitate fracing.

In an example embodiment, the hydraulic fracturing pump 30 may be configured to pump over a wide range of pressures, such as 7,000 PSI-13,000 PSI (about 48.26 MPa-about 89.63 MPa). Thus, the torque to drive the hydraulic fracturing pump 30 may be significant. The turbine engine 10 may be configured to drive the transmission 20 and the transmission 20 may be configured to drive the hydraulic fracturing pump 30 over a variety of pressure load conditions.

Turning to FIG. 2A, the turbine engine 10 may have various features. For instance, a compressor section 202 may ingest air having an oxidizer therein through an inlet 208 and compress the air. The inlet 208 may be one or more aperture that receives air containing the oxidizer. The compressor section 202 may provide the compressed air to the power section 204. The power section 204 may introduce fuel and may combust the fuel in the presence of the air having the oxidizer. The power section 204 may expel the combustion products and any remaining air through an exhaust outlet 210. The combustion may generate power to turn a power shaft 206. The power shaft 206 may be connected to the transmission 20 (FIG. 1) which drives the hydraulic fracturing pump 30 (FIG. 1).

The improved hydraulic fracturing power system 2 may also include an evaporative cooling apparatus 300 as illustrated in FIG. 2A. The evaporative cooling apparatus 300 cools the air before the air enters the inlet 208 in order to densify the air and increase a quantity of oxidizer in a unit volume of the air. FIG. 2B illustrates a chart 250 of operative principles associated with the evaporative cooling apparatus 300 (FIG. 2A). As illustrated, by using passing airflow to dry a moist component of the evaporative cooling apparatus 300, the passing airflow cools, thus densifying.

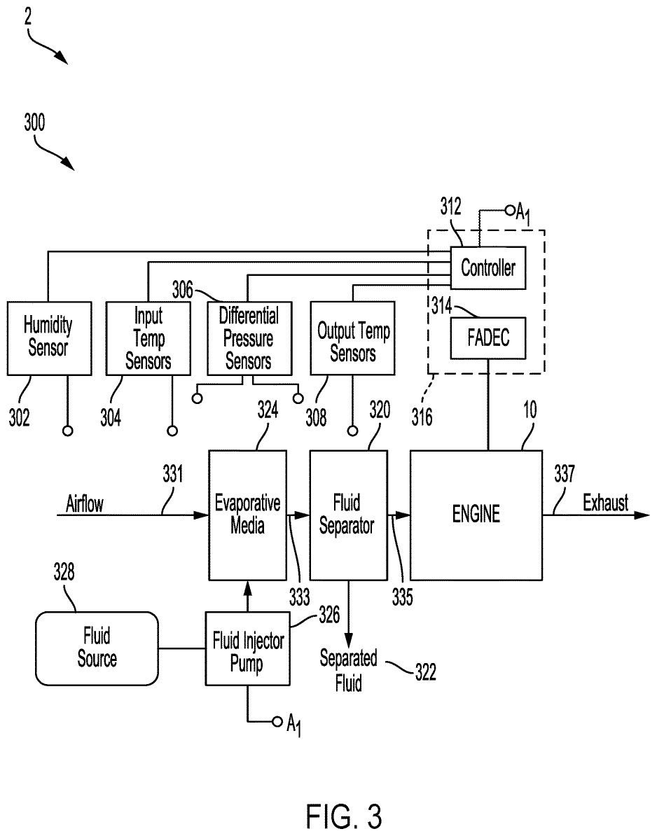

With reference to FIG. 3, an example block diagram of an improved hydraulic fracturing power system 2 that includes the evaporative cooling apparatus 300 is depicted. In various embodiments, the evaporative cooling apparatus 300 receives an incipient airflow 331 into an evaporative media 324. The evaporative media 324 may have a fluid instilled therein, such as by a fluid injection pump 326 connected to a fluid source 328. The evaporative media 324 may cool the incipient airflow 331 to create a cooled airflow 333. The cooled airflow 333 may pass through a fluid separator 320 to extract the fluid from the cooled airflow 333 to provide a cooled and dried airflow 335. The cooled and dried airflow 335 is provided to the inlet 208 (FIG. 2A) of the turbine engine 10. The combustion products that leave the turbine engine 10 via the exhaust outlet 210 (FIG. 2A) may be expelled as exhaust 337. In various instances, the fluid separator 320 is omitted and the cold airflow 333 is provided directly to the inlet 208 (FIG. 2A) as cooled and dried airflow 335, the airflow already being adequately dry for engine operation.

The evaporative cooling apparatus 300 may have various features, some of which have been briefly introduced above. For example, the evaporative cooling apparatus 300 may have a sensor array 318. The sensor array 318 may include one or more sensor that provides data to a controller 312. The controller 312 may selectively direct a fluid injection pump 326 to instill more or less fluid into the evaporative media 324 to modulate an amount of cooling provided to the airflow 331. The controller 312 may perform this selective direction in response to data provided by the sensor array 318.

The sensor array 318 may include a humidity sensor 302. For instance, a humidity sensor 302 is any sensor that can detect an amount of fluid in a gas, such as ambient air. The humidity sensor 302 may detect a humidity of the incipient airflow 331, the cooled airflow 333, and/or the cooled and dried airflow 335 as desired in order to aid modulation of the amount of fluid instilled in the evaporative media 324.

The sensor array 318 may include an input temperature sensor 304. An input temperature sensor 304 may comprise any sensor configured to detect a temperature of airflow 331 to enter the evaporative media 324.

The sensor array 318 may include an output temperature sensor 308. The output temperature sensor 308 may comprise any sensor configured to detect a temperature of cooled airflow 333 to exit the evaporative media 324, or cooled and dried airflow 335 to exit the fluid separator 320 in route for ingestion into the turbine engine 10.

The sensor array 318 may include a differential pressure sensor 306. The differential pressure sensor 306 may measure a pressure in the airflow 331 prior to entering the evaporative media 324 and may measure a pressure in the cooled airflow 333 after departing the evaporative media 324. Changes in the detected differential between the pressures may correspond to clogging of the evaporative media 324 and/or may correspond to a fluid saturation of the evaporative media 324. The differential pressure sensor 306 is connected to a controller 312 which may take a responsive action such as providing a human-readable alert, adjusting a power setting of the turbine engine 10, adjusting an amount of fluid being instilled into the evaporative media 324, or actuating an automated process to replace or clean the evaporative media 324.

The evaporative cooling apparatus 300 may include a fluid separator 320 briefly introduced above. The fluid separator 320 may receive cooled airflow 333 and separate fluid from the cooled airflow 333 to create cooled and dried airflow 335 that is then introduced into an inlet 208 of the turbine engine 10. The fluid separator 320 may have a separated fluid outlet 322 that conducts the fluid away from the airflow. For instance, the separated fluid outlet 322 may convey the fluid into a fluid source 328 or back to the fluid injection pump 326 for recycling. The separated fluid outlet 322 may be a pipe, a hose, a collection vessel or any other structure as desired.

The evaporative cooling apparatus 300 may include the fluid injection pump 326. The fluid injection pump 326 may be any mechanism by which fluid may be controllably instilled into the evaporative media 324. The fluid may be provided to the fluid injection pump 326 from a fluid source 328. The fluid source 328 may comprise a pipe, a hose, another connection, a container, or the like. The fluid may be a coolant and/or an evaporant.

The evaporative cooing apparatus 300 may include the evaporative media 324. The evaporative media 324 may include any media upon which fluid may be instilled to cool a gas passing through the evaporative media 324. For instance, the evaporative media 324 may include a mesh or lattice, or honeycomb, or grid or irregular media, or any other structure as desired.

Finally, the evaporative cooling apparatus 300 may include a controller 312. The controller 312 may be a computer, a special-purpose computer, a field-programmable gate array (FPGA), one or more application-specific integrated circuits, and/or the like. The controller 312 is connected to the sensor array 318 and is connected to the fluid injection pump 326 and modulates a timing and amount of fluid instilled into the evaporative media 324 by the fluid injection pump 326. The controller 312 may perform the modulation in response to the sensor array 318. The controller 312 may be a logical aspect of a full authority digital engine controller (FADEC) 314 that controls the turbine engine 10 or may be a separate device that is connected to the FADEC 314. In various embodiments, the FADEC 314 and the controller 312 may be logical aspects of an integrated control unit 316 comprising a computer, a special-purpose computer, a field programmable gate array, one or more application specific integrated circuits, and/or the like.

Having introduced various aspects of an improved hydraulic fracturing power system 2, attention is now directed to the combined set of FIGS. 1-3 for a discussion of different example embodiments of the system 2.

For instance, an evaporative cooling apparatus 300 for a turbine engine 10 is provided. The evaporative cooling apparatus 300 may have various features. For instance, the evaporative cooling apparatus 300 may include an evaporative media 324 disposed in an airflow path of an inlet 208 into a turbine engine 10. The evaporative cooling apparatus 300 may include a fluid separator 320 disposed in an airflow path of an inlet 208 into a turbine engine 10. The fluid separator 320 may be positioned between the evaporative media 324 and the inlet 208. The evaporative media 324 introduces fluid into the airflow path to cool an airflow 331 in the airflow path to create cooled airflow 333. The fluid separator 320 recovers fluid from the cooled airflow 333 to create cooled and dried airflow 335. The cold and dried airflow 335 passes from the fluid separator 320 into the inlet 208 of the turbine engine 10.

In various embodiments, the fluid separator 320 may include various different operative mechanisms to recover fluid from the cooled airflow 333 to create cooled and dried airflow 335. For instance, beyond removing humidity from the cooled airflow 333, the fluid separator 320 may work to collect carry-over droplets that are picked up by the airflow from the evaporative media 324 and carried in the flowing air of the airflow path so that they travel in the cooled airflow 333. The fluid separator may also include a mechanism for removing these droplets as well. For instance, the fluid separator may include one or more mechanical separator, such as a zig-zag path wherein the droplets contact a surface of the path and dribble or otherwise travel into a collection pan for collection. The fluid separator may include one or more cooling device to cool the airflow further and cause humidity to condense out of the air. Thus, the fluid separator 320 may have both a mechanical separator and a cooling device. The fluid separator 320 may have a drain pain that collects the collected water, whether from humidity and/or from carry-over droplets, accumulating separated fluid 322 for collection, removal, and/or possible reuse as detailed elsewhere herein. In yet further instances, the fluid separator 320 is omitted.

One or more further features may also be provided. For instance, the evaporative cooling apparatus 300 may include a differential pressure sensor 306. The sensor may have sensing elements disposed on opposite sides of the evaporative media 324 to detect a difference in pressure, the difference corresponding to a clogging of the evaporative media 324 and/or a fluid saturation of the evaporative media 324. The evaporative cooling apparatus 300 may include a fluid injection pump 326 attached to the evaporative media 324 to instill the fluid into the evaporative media 324. The evaporative cooling apparatus 300 may include a fluid source 328 attached to the fluid injection pump 326 to provide the fluid to the fluid injection pump 326. The fluid separator 320 may include a separated fluid outlet 322 connected to the fluid source 328 to provide a recycled portion of the fluid.

The evaporative cooling apparatus 300 may include a controller 312. The controller 312 may be connected to the fluid injection pump 326 and a sensor array 318. The controller 312 may be configured to modulate an amount of the fluid selectively instilled into the evaporative media 324 in response to the sensor array 318. The sensor array 318 may include a differential pressure sensor 306 having sensing elements disposed on opposite sides of the evaporative media 324 to detect a difference in pressure. The difference may correspond to at least one of (1) a fluid saturation of the evaporative media 324 and (2) a clogging of the evaporative media 324.

The sensor array 318 may include a humidity sensor 302 to detect an ambient humidity. The sensor array 318 may include an input temperature sensor 304 to detect a temperature of the airflow 331 in the airflow path that is flowing into the evaporative media 324. The sensor array 318 may include an output temperature sensor 308 to detect a temperature of the cooled airflow 333 flowing out of the evaporative media 324. The sensor array 318 may include an output temperature sensor 308 to detect a temperature of the dried and cooled airflow 335 such as the dried and cooled airflow 335 flowing out of the fluid separator 320.

The controller 312 may selectively increase the amount of the fluid selectively instilled into the evaporative media 324 in response to the output temperature sensor 308 indicating a temperature above a first threshold.

The controller 312 may operate according to more complex operations, as well. For instance, a psych chart operation depends on a starting point, which may be defined by any two of dry bulb temperature, wet bulb temperature, and relative humidity. The controller 312 may monitor the sensor array 318 to achieve more complex operations. For instance, by determining a starting point and achievable amount of cooling, and commanding a flow of water to the evaporative media 324 accordingly.

By finding a starting point and following a line to the 100% relative humidity curve, then dehumidification may be characterized by movement along a corresponding line with further cooling. One may then heat back up going straight across to the right on the psych chart, so as to achieve a desired exit temperature and humidity.

The controller 312 may be a logical component of a turbine engine 10 full authority digital electronic controller (FADEC) that controls the turbine engine 10. The controller 312 may be in operative communication with a turbine engine 10 full authority digital electronic controller (FADEC) 314 that controls the turbine engine 10 to form an integrated control unit 316 comprising the FADEC 314 and the controller 312.

An improved hydraulic fracturing power system 2 is provided. The system 2 may include a turbine engine 10 having an inlet 208, an exhaust outlet 210, and a power shaft 206 to drive a load. The system 2 may include a transmission 20 connected to the power shaft 206 of the turbine engine 10. The system 2 may include a hydraulic fracturing pump 30 connected to the transmission 20 as the load. The transmission 20 couples motive force from the turbine engine 10 to the hydraulic fracturing pump 30 to operate the hydraulic fracturing pump 30. The system 2 may include an evaporative cooling apparatus 300 disposed adjacent to the inlet 208 to cool airflow 331 into the turbine engine 10.

One or more further features may also be provided. For instance, a fluid separator 320 may be disposed between the evaporative cooling apparatus 300 and the inlet 208 to separate fluid from the airflow prior to the inlet 208 of the turbine engine 10. In various embodiments, the system 2 includes a fluid injection pump 326 and a controller 312. The fluid injection pump 326 is connected to an evaporative media 324 of the evaporative cooling apparatus 300. The fluid injection pump 326 instils fluid into the evaporative cooling apparatus 300 to induce evaporative cooling of the airflow. The controller 312 is connected to the fluid injection pump 326 to modulate an amount of the fluid to increase or decrease a cooling effect of the evaporative cooling apparatus 300. The system 2 may include a sensor array 318. The sensor array 318 may be connected to the controller 312. The sensor array 318 may include an output temperature sensor 308 to measure a temperature of the airflow between the evaporative media 324 and the inlet 208 of the turbine engine 10. The controller 312 may increase the amount of fluid to decrease the temperature.

The improved hydraulic fracturing power system 2 may include a full authority digital engine controller (FADEC) 314 controlling the turbine engine 10. The controller 312 may be connected to the FADEC 314. The controller 312 may increase the amount of fluid to decrease a temperature of the airflow in response to an instruction from the FADEC 314 to increase a power delivered by the turbine engine 10 to the load. The controller 312 may be a logical aspect of the FADEC 314 and may be integrated therein.

A turbine engine 10 is provided. The turbine engine 10 may include an inlet 208 to receive an airflow. The turbine engine 10 may include a compressor section 202 to compress the airflow. The turbine engine 10 may include a power section 204 to combust a fuel oxidized by the airflow to generate power and combustion products. The turbine engine 10 may include a power shaft 206 to output the power to a load. The turbine engine 10 may include an exhaust outlet 210 to expel the combustion products. The turbine engine 10 may include an evaporative cooling apparatus 300 disposed adjacent to the inlet 208. The evaporative cooling apparatus 300 may receive the airflow prior to the airflow passing into the inlet 208. The evaporative cooling apparatus 300 may cool the airflow to increase the power generated by the combusting the fuel oxidized by the airflow by increasing a density of a gas of the airflow.

The turbine engine 10 may have one or more additional features. For instance, the evaporative cooling apparatus 300 of the turbine engine 10 may include further aspects. The evaporative cooling apparatus 300 may include an evaporative media 324 disposed in a path of the airflow into the inlet 208. The evaporative cooling apparatus 300 may include a fluid separator 320 disposed in the path of the airflow and positioned between the evaporative media 324 and the inlet 208. The evaporative media 324 may introduce fluid into the airflow 331 to cool the airflow 331 to create cooled airflow 333. The fluid separator 320 recovers fluid from the cooled airflow 333 to create cooled and dried airflow 335. The cold and dried airflow 335 passes from the fluid separator 320 into the inlet 208 to receive the airflow.

The turbine engine 10 may include one or more additional aspect. For instance, the turbine engine 10 may include a fluid injection pump 326 and a controller 312. The fluid injection pump 326 may be connected to an evaporative media 324 of the evaporative cooling apparatus 300. The fluid injection pump 326 instils fluid into the evaporative cooling apparatus 300 to induce evaporative cooling of the airflow. The controller 312 may be connected to the fluid injection pump 326 to modulate an amount of the fluid to increase or decrease a cooling effect of the evaporative cooling apparatus 300 in response to an instruction from a full authority digital engine controller (FADEC) controlling the turbine engine 10. The instruction may be an instruction to increase the power generated by the turbine engine 10.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Further, it should be noted that the system may employ any number of conventional techniques for data transmission, signaling, data processing, network control, and the like.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a removable memory chip (such as an erasable programmable read only memory (EPROM), programmable read only memory (PROM)) and associated socket, or other removable storage units and interfaces, which allow software and data to be transferred from the removable storage unit to a computer system.

The computer system or device may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. An evaporative cooling apparatus for a turbine engine, the evaporative cooling apparatus comprising:
an evaporative media disposed in an airflow path of an air inlet into a turbine engine; and
a fluid separator disposed in the airflow path of the air inlet into the turbine engine, the fluid separator positioned between the evaporative media and the air inlet,
wherein the evaporative media introduces fluid into the airflow path to cool an airflow in the airflow path to create a cooled airflow,
wherein the fluid separator recovers fluid from the cooled airflow to create a cooled and dried airflow, and
wherein the cold and dried airflow passes from the fluid separator into the air inlet of the turbine engine.

2. The evaporative cooling apparatus according to claim 1, further comprising a differential pressure sensor having sensing elements disposed on opposite sides of the evaporative media to detect a difference in a pressure, the difference corresponding to a clogging of the evaporative media.

3. The evaporative cooling apparatus according to claim 1, further comprising a fluid injection pump attached to the evaporative media to instill the fluid into the evaporative media.

4. The evaporative cooling apparatus according to claim 3, further comprising a fluid source attached to the fluid injection pump to provide the fluid to the fluid injection pump.

5. The evaporative cooling apparatus according to claim 4, wherein the fluid separator comprises a separated fluid outlet connected to the fluid source to provide a recycled portion of the fluid.

6. The evaporative cooling apparatus according to claim 3, further comprising a controller, the controller connected to the fluid injection pump and a sensor array, the controller configured to modulate an amount of the fluid selectively instilled into the evaporative media in response to the sensor array.

7. The evaporative cooling apparatus according to claim 6, wherein the sensor array comprises a differential pressure sensor having sensing elements disposed on opposite sides of the evaporative media to detect a difference in a pressure, the difference corresponding to at least one of (1) a fluid saturation of the evaporative media and (2) a clogging of the evaporative media.

8. The evaporative cooling apparatus according to claim 6, wherein the sensor array comprises:
a humidity sensor to detect an ambient humidity;
an input temperature sensor to detect a temperature of the airflow in the airflow path that is flowing into the evaporative media; and
an output temperature sensor to detect a temperature of the cooled airflow flowing out of the evaporative media.

9. The evaporative cooling apparatus according to claim 8, wherein the controller selectively increases an amount of the fluid selectively instilled into the evaporative media in response to the output temperature sensor indicating a temperature above a first threshold.

10. The evaporative cooling apparatus according to claim 6, wherein the controller is a logical component of a full authority digital electronic controller (FADEC) that controls the turbine engine.

11. The evaporative cooling apparatus according to claim 6, wherein the controller is in operative communication with a full authority digital electronic controller (FADEC) that controls the turbine engine to form an integrated control unit comprising the FADEC and the controller.

12. An improved hydraulic fracturing power system comprising:
a turbine engine having an inlet, an exhaust outlet, and a power shaft to drive a load;
a transmission connected to the power shaft of the turbine engine;
a hydraulic fracturing pump connected to the transmission as the load, wherein the transmission couples motive force from the gas turbine energy to the hydraulic fracturing pump to operate the hydraulic fracturing pump; and
an evaporative cooling apparatus disposed adjacent to the inlet to cool airflow into the turbine engine.

13. The improved hydraulic fracturing power system according to claim 12, further comprising:
a fluid separator disposed between the evaporative cooling apparatus and the inlet to separate fluid from the airflow prior to the inlet of the turbine engine.

14. The improved hydraulic fracturing power system according to claim 12, further comprising:
a fluid injection pump connected to an evaporative media of the evaporative cooling apparatus, wherein the fluid injection pump instils fluid into the evaporative cooling apparatus to induce evaporative cooling of the airflow; and
a controller connected to the fluid injection pump to modulate an amount of the fluid to increase or decrease a cooling effect of the evaporative cooling apparatus.

15. The improved hydraulic fracturing power system according to claim 14, further comprising a sensor array connected to the controller, the sensor array including an output temperature sensor to measure a temperature of the airflow between the evaporative media and the inlet of the turbine engine, wherein the controller increases the amount of fluid to decrease the temperature.

16. The improved hydraulic fracturing power system according to claim 15, further comprising a full-authority digital engine controller (FADEC) controlling the turbine engine, wherein the controller is connected to the FADEC and increases the amount of fluid to decrease the temperature in response to an instruction from the FADEC to increase a power delivered by the turbine engine to the load.

17. The improved hydraulic fracturing power system according to claim 16, wherein the controller is a logical aspect of the FADEC and is integrated therein.

18. A turbine engine comprising:
an inlet to receive an airflow;
a compressor section to compress the airflow;
a power section to combust a fuel oxidized by the airflow to generate power and combustion products;
a power shaft to output the power to a load;
an outlet to expel the combustion products; and
an evaporative cooling apparatus disposed adjacent to the inlet to receive the airflow prior to the airflow passing into the inlet, wherein the evaporative cooling apparatus cools the airflow to increase the power generated by the combusting the fuel oxidized by the airflow by increasing a density of a gas of the airflow.

19. The turbine engine according to claim 18, wherein the evaporative cooling apparatus comprises:
an evaporative media disposed in a path of the airflow into the inlet; and
a fluid separator disposed in the path of the airflow and positioned between the first evaporative media and the inlet,
wherein the evaporative media introduces fluid into the airflow to cool the airflow to create a cooled airflow,
wherein the fluid separator recovers fluid from the cooled airflow to create a cooled and dried airflow, and
wherein the cold and dried airflow passes from the fluid separator into the inlet.

20. The turbine engine according to claim 19, further comprising:
a fluid injection pump connected to the evaporative media of the evaporative cooling apparatus, wherein the fluid injection pump instils fluid into the evaporative cooling apparatus to induce evaporative cooling of the airflow; and
a controller connected to the fluid injection pump to modulate an amount of the fluid to increase or decrease a cooling effect of the evaporative cooling apparatus in response to an instruction from a full authority digital engine controller (FADEC) controlling the turbine engine, the instruction being an instruction to increase the power generated by the turbine engine.
